(19) United States
(12) Patent Application Publication
(10) Pub. No.: US 2019/0279301 A1
(43) Pub. Date: Sep. 12, 2019

(54) Systems and Methods Using an Algorithmic Solution for Analyzing a Portfolio of Stocks, Commodities and/or Other Financial Assets Based on Individual User Data to Achieve Desired Risk Based Financial Goals

(71) Applicant: Dhruv Siddharth KRISHNAN, Tampa, FL (US)

(72) Inventor: Dhruv Siddharth KRISHNAN, Tampa, FL (US)

(21) Appl. No.: 16/404,243

(22) Filed: May 6, 2019

(51) Int. Cl. G06Q 40/04; G06Q 10/06; G06Q 30/00; G06Q 30/02

(52) U.S. Cl. CPC G06Q 40/04; G06Q 30/0214; G06Q 30/018; G06Q 10/067

(57) ABSTRACT

A multi-factor qualitative method for assessing assets including receiving market data from a plurality of market data sources for processing by a trading app to make decisions as to whether to buy, sell, or hold a particular market asset; applying a data normalizer to the market data for processing dissimilar sets of market data; receiving, by user input, a particular market asset in which a decision is required; processing, the market data by a complex event processing engine using an algorithmic solutions from a particular sector for market analysis of market data to generate a multi-factor model wherein the multi-factor model comprises: at least one of a set of a plurality of multi-factors related to the particular sector; applying, the multi-factor model by the trading app, to perform a multi-factor analysis making a decision whether to buy, sell or hold the market asset based on a normalized score.

### TECHNICAL FIELD

The technical field generally relates to selecting financial product for investment, and more particularly relates to systems, and methods for analyzing an individual financial portfolio using an algorithmic solution to generate an individual investment plan based on user data, to automate financial investments, to charge risk based commissions, and to limit individual risks and losses in order to achieve desired financial goals.

### INTRODUCTION

Today quantitative investing has become a choice investment tool by large banks and hedge funds on Wall Street. That is, algorithmic solutions to enable analysis and investment on stocks and other financial products are being used more often with greater degrees of effectiveness.

Through analyzing market observations, quantitative finance (QF) utilizes mathematical models to search for subtle patterns and inefficiencies in financial markets to improve prospective profits. To discover profitable signals in anticipation of volatile trading patterns amid a global market, analytics are carried out on market metadata with a complex process in pursuit of an infinitesimal time amount such as microsecond or even a nanosecond of processing advantage; which can translate by cumulative effect in significant profit gains.

There are mainly three types of trading strategies to construct in financial machine learning industry, i.e. asset selection, which selects potentially most profitable assets to invest, portfolio management, which distributes fund into the assets to optimize the risk-profit profile, and timing, which determines the time to enter or leave the market. The first part of asset selection which when performed effectively can be considered the guiding underlying principle of an automated trading system. The holy grail of stock selection is to pick or predict to time to select stocks with companies that are experiencing high growth beyond analyst expectations generating higher than expected price returns that have not already been priced into a current stock price. The use of the appropriate algorithms is absolutely vital to making such complex predictions which requires analyzing quorums of data instantaneously to make such selections and to change selections in real-time which in turn gives individuals with access to such tools substantial insight to price predictability when trading in stocks to achieve financial goals thereby limiting overall risks.

Hence with the advent of such algorithmic solutions, often is the case that the individual stock investor is left out and cannot achieve such desired goals. Moreover, even if accessible by the individual investor, there is limited if any personal attention and personal tailoring to an individual portfolio due to little profit realized on small individual portfolio in comparison to large aggregations of monies from pension funds and hedge funds.

In addition, there a need for qualitative and quantitative financial investing that can be performed by the individual investor. That is, there is a need for combining Warren Buffet's general financial principles of investing in what you know and the Harry Markowitz style of investing which is based on the diversification theory and not betting on a single performing stock.

Accordingly, it is desirable to enable quantitative and qualitative algorithmic solutions that enables an individual investor in analyses of his/her portfolio and to create an algorithmic plan based on initial goals. Further is desired that once the individual's need are determined, the algorithm can create a low risk investment plan. Using a quantitative and qualitative approach to determine financial goals for creating a investment portfolio or creates analysis of portfolio and data for investors to use while creating a personal algorithmic trading system.

It is desirable for an individual algorithmic solution that will compile buyable assets from the markets and send the data to the individual to approve for purchase. When completed, the algorithm will charge a certain percentage of commission on all approved trades.

Furthermore, other desirable features and characteristics of the present invention will become apparent from the subsequent detailed description and the appended claims, taken in conjunction with the accompanying drawings and the foregoing technical field and background.

### SUMMARY

Systems, methods and apparatuses for using a quantitative approach to determine financial goals for creating an investment portfolio or creates analysis of portfolio and data for investors to use with factors of an algorithmic trading system are provided.

In one embodiment, a multi-factor qualitative method for assessing assets is provided. The method includes: receiving market data from a plurality of market data sources for processing by a trading app to make decisions as to whether to buy, sell, or hold a particular market asset; applying a data normalizer to the market data for processing dissimilar sets of market data; receiving, by user input, a particular market asset in which a decision to buy, sell or hold is required; processing, the market data by a complex event processing engine using an algorithmic solutions from a particular sector for market analysis of market data to generate a multi-factor model wherein the multi-factor model comprises: at least one of a set of a plurality of multi-factors related to the particular sector; applying, the multi-factor model by the trading app, to perform a multi-factor analysis of the particular market asset and to generate a set of results; and making a decision about the particular market asset by the trading app, from the set of results of whether to buy, sell or hold the market asset based on a normalized score in the range of plus one to minus one of the set of results wherein a plus one score indicates a decision to buy and a negative one score indicates a decision to sell.

In various exemplary embodiments, the method includes: creating, by the trading app, a user profile for each user wherein the user profile is an additional factor used in the multi-factor model for making a decision whether to buy, sell or hold the particular market asset. The method, further includes: executing, by an order manager of the trading app, the buy or sell decisions in increments in order maximize profits by preventing increases or reductions in a price of the particular market asset that results from executions of a buy and a sell of a block of the particular market asset.

The method, further includes: creating, a simulator exchange, to model prior to executing the buy or the sell of the block of the particular asset, a simulated buy or sell to determine if one or more expected results are achieved or not. The method, further includes: applying one or more financial checks by the trading app to ensure that a particular buy or sell of the particular market asset is in compliance. The method, further includes: applying the algorithmic solution for an information technologies market sector based on one or more factors including: a difference in percentage of costs of software services compared to competitors; a difference in sales of products compared to competitors; and a difference in increased revenue compared to competitors.

The method, further includes: applying the algorithmic solution for a telecommunication market sector based on one or more factors including: a difference in percentage of costs for regulations added in previous years; a correlation of interest rates affecting market assets; a difference in growth compared to previous years of growth; and an amount of a change in a number of users for a particular related product or software services to the market asset.

In another embodiment, a computer program product tangibly embodied in a computer-readable storage device and comprising instructions configurable to be executed by a processor to perform a method for determining market assets based on a set of multiple qualitative and quantitative factors selected by the user using a software product for trading market assets is provided. The method includes: receiving market data from a plurality of market data sources for processing by the software product comprising a trading app to make decisions as to whether to buy, sell, or hold a particular market asset; applying a data normalizer to the market data for processing dissimilar sets of market data; receiving, by user input to the trading app, a particular market asset in which a decision to buy, sell or hold is required; processing, the market data by a complex event processing engine using an algorithmic solutions from a particular sector for market analysis of market data to generate a multi-factor model wherein the multi-factor model comprises: at least one of a set of a plurality of multi-factors related to the particular sector; applying, the multi-factor model by the trading app, to perform a multi-factor analysis of the particular market asset and to generate a set of results; and making a decision about the particular market asset by the trading app, from the set of results whether to buy, sell or hold the market asset based on a normalized score in the range of plus one to minus one of the set of results wherein a plus one score indicates a decision to buy and a negative one score indicates a decision to sell.

In various exemplary embodiment, the method includes: creating, by the trading app, a user profile for each user wherein the user profile is an additional factor used in the multi-factor model for making a decision whether to buy, sell or hold the particular market asset. The method, further includes: executing, by an order manager of the trading app, the buy or sell decisions in increments in order maximize profits by preventing increases or reductions in a price of the particular market asset that results from executions of a buy and a sell of a block of the particular market asset. The method further includes: creating, a simulator exchange, to model prior to executing the buy or the sell of the block of the particular asset, a simulated buy or sell to determine if one or more expected results are achieved or not. The method, further includes: applying one or more financial checks by the trading app to ensure that a particular buy or sell of the particular market asset is in compliance. The method further includes: applying the algorithmic solution for an information technologies market sector based on one or more factors including: a difference in percentage of costs of software services compared to competitors; a difference in sales of products compared to competitors; and a difference in increased revenue compared to competitors. The method, further includes: applying the algorithmic solution for a telecommunication market sector based on one or more factors including: a difference in percentage of costs for regulations added in previous years; a correlation of interest rates affecting market assets; a difference in growth compared to previous years of growth; and an amount of a change in a number of users for a particular related product or software services to the market asset. The software product includes a software-as-a-service (SaaS) application. The software product includes a cloud application.

In yet another embodiment, a system including: at least one processor; and at least one computer-readable storage device comprising instructions configurable to be executed by the at least one processor to perform a method for making decisions about market assets using a multi-factor qualitative model of a cloud trading app, the method includes: receiving market data from a plurality of market data sources for processing by the software product comprising a trading app to make decisions as to whether to buy, sell, or hold a particular market asset; applying a data normalizer to the market data for processing dissimilar sets of market data; receiving, by user input to the trading app, a particular market asset in which a decision to buy, sell or hold is required; processing, the market data by a complex event processing engine using an algorithmic solutions from a particular sector for market analysis of market data to generate a multi-factor model wherein the multi-factor model comprises: at least one of a set of a plurality of multi-factors related to the particular sector; applying, the multi-factor model by the trading app, to perform a multi-factor analysis of the particular market asset and to generate a set of results; and making a decision about the particular market asset by the trading app, from the set of results whether to buy, sell or hold the market asset based on a normalized score in the range of plus one to minus one of the set of results wherein a plus one score indicates a decision to buy and a negative one score indicates a decision to sell.

In various exemplary embodiments, the system includes: generating a multi-factor model for an information technologies market sector based on one or more factors including: data of a difference in percentage of costs of software services compared to competitors; data of a difference in sales of products compared to competitors; and data of a difference in increased revenue compared to competitors. The system, further includes: generating a multi-factor model for a telecommunication market sector based on one or more factors including: data of a difference in percentage of costs for regulations added in previous years; data of a correlation of interest rates affecting market assets; data of a difference in growth compared to previous years of growth; and data of an amount of a change in a number of users for a particular related product or software services to the market asset.

The system, further includes: one or more financial checks executed by the trading app to ensure that a particular buy or sell of the particular market asset is in compliance with securities trading regulations.

It is noted that in various embodiments, the method contains steps which correspond to the functions of one or more of the various embodiments of the trading app system and apparatus described above.

### BRIEF DESCRIPTION OF THE DRAWINGS

The exemplary embodiments will hereinafter be described in conjunction with the following drawing figures, wherein like numerals denote like elements, and wherein:

FIG. 1 illustrates a functional block diagram of an exemplary trading application using a Multi-Factor Qualitative Application (hereinafter “MFQA”) in accordance with an embodiment;

FIG. 2 illustrates an exemplary functional block diagram illustrating the strategy settings and user interface using the MFQA application in accordance with an embodiment;

FIG. 3 illustrates an exemplary diagram of the order management system when asset transactions are scheduled for transactions in the marketplace in accordance with an embodiment;

FIG. 4 illustrates an exemplary block diagram demonstrating the Complex Event Processing system using sector equations using various quantitative and qualitative analytics to initialize the trading app system in accordance with an embodiment;

FIG. 5 illustrates an exemplary diagram of sector equations for use by the trading app, in accordance with an embodiment;

FIG. 6 illustrates an exemplary diagram that illustrates the market data sources that can be used for implementing the Multi-Factor Qualitative Application (MFQA) for the trading app in accordance with embodiment;

FIG. 7 illustrates an exemplary diagram of performance monitoring 700 in the trading app in accordance with an embodiment;

FIG. 8 illustrates an exemplary diagram that illustrates an Application Risk Management System and Fraud Monitor system configured in the trading app in accordance with an embodiment;

FIGS. 9A and 9B are flowcharts that illustrate the flow process for various sector implementations of in the trading app, in accordance with an embodiment; and

FIG. 10 is an example trading app, in accordance with an embodiment.

### DETAILED DESCRIPTION

The investment industry is becoming increasingly automated with more sophisticated algorithms for analyzing and balancing the investments in an asset portfolio.

With the increase of automation within the financial industry, the need of more rapid asset building models and algorithms are necessary for financial evolution.

In various exemplary embodiments, methods and systems are provided of a quantitative algorithm that analyzes a person's initial portfolio and creates an algorithmic plan based on initial goals of the client. When the client's need is determined, the algorithm will create a low-risk investment plan for the client. The algorithm will compile buyable assets from the markets and send the data to the client to approve for purchase. When completed, the algorithm will charge a certain percentage of commission on all approved trades.

The Fama and French Three-Factor Model is an asset pricing model that expands on the capital asset pricing model (CAPM) by adding size risk and value risk factors to the market risk factor in CAPM. This model considers the fact that value and small-cap stocks outperform markets on a regular basis compared to large cap stocks. According to Fama and French, the attraction of the Fama and French Three-Factor Model (FFM) offers powerful and intuitively pleasing predictions about how to measure risk and the relation between expected return and risk.

The traditional asset pricing model, known formally as the capital asset pricing model (CAPM) uses only factor of risk (beta) to describe the returns of a portfolio or stock with the returns of the market as a whole. In contrast, the Fama-French model uses three variables. Fama and French started with the observation that two classes of stocks have tended to do better than the market as a whole: (i) small caps and (ii) stocks with a high book-to-market ratio (B/P, customarily called value stocks, contrasted with growth stocks). They then added two factors to CAPM to reflect a portfolio's exposure to these two classes:

r=R_{f}+β(Rₘ−R_{f})+bₛ·SMB+bᵥ·HML+α

Here r is the portfolio's expected rate of return, R_{f} is the risk-free return rate, and Rₘ is the return of the market portfolio. The “three factor” β is analogous to the classical β but not equal to it, since there are now two additional factors to do some of the work. SMB stands for “Small [market capitalization] Minus Big” and HML for “High [book-to-market ratio] Minus Low”; to measure the historic excess returns of small caps over big caps and of value stocks over growth stocks.

However, today capital markets and exchanges are much more complex and the Fama-French 3 model no longer provides as accurate results when applied to today's markets due to the significant volume of data and multi-factors that influence the market. In today's modern day electronic automated stock market with the extreme amount of liquidity and over 50 different electronic exchanges, the Fama-French model uses only 3 variables and the three variables of size premium, value premium and beta don't measure the complexity of the capital markets and doesn't measure the volatility of the capital markets. In other words, the narrow class of application that the Fama-French model relied on is no longer applicable.

Attempts have been made to overcome the deficiencies of the Fama-French model. One such alternative is the RBSA uses the capital asset pricing model as its backbone, of which William Sharpe was also a primary contributor. In CAPM, a single index is often used as a proxy to represent the return of the market. The first step is to extend this to allow for multiple market proxy indices, thus:

$${R}_{t}^{m} = α + {\sum }_{i = 1}^{I} {β}^{i} {R}_{t}^{i} + {ϵ}_{t}$$

However, the CAPM suffers from similar deficiencies given the complexities of even a single index market and is no longer deemed of sufficient accuracy for asset pricings.

Lastly and more recently, Fama-French developed a 5 factor model to help with 21^{st} century financial markets. The two new factors that are demonstrated by Fama-French include profitability and investment. However, investors have some concerns about the new asset pricing model such as the missing of momentum and volatility. Many investors believe that that the new factors are two closely related and this equation isn't much of a change compared to the original Fama-French 3 factor model. Quant researchers also believe this equation doesn't account for risk within the entire market entirely making the equation inefficient. Others conjure that there wasn't any explanation for these new factors.

Therefore, it is desirable to expand the factors and to re-evaluate the methodology used by the 3 factor model with an enhanced set of factors and additional changes in the model that are more applicable to today's capital markets.

The present disclosure describes various systems and methods for analyzing an asset portfolio and for applying a Multi-Factor Qualitative Application (hereinafter “MFQA”) which is parameterized in accordance with empirical testing to re-distribute the assets in a portfolio and for taking into account the personal profile data of the investor.

In various embodiments, the assets may be re-balanced in accordance with investor social affinities and principles. For example, if the personal profile data of an investor indicates a proclivity to “green” investments, the portfolio will be rebalanced with an asset mix in accordance with this likeness or preference.

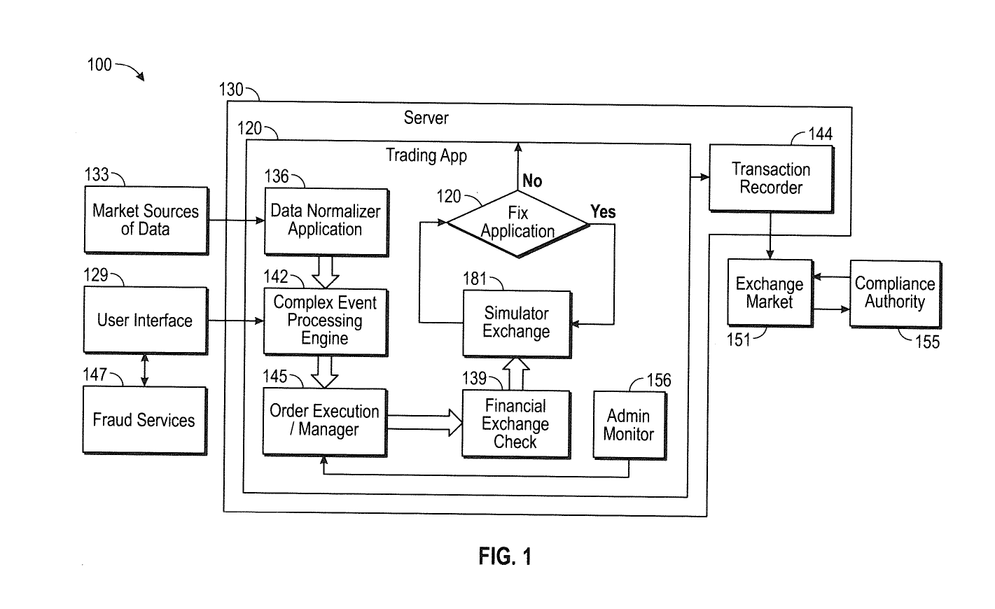

FIG. 1 illustrates a functional block diagram of an exemplary trading application using a Multi-Factor Qualitative Application (hereinafter “MFQA”) in accordance with an embodiment. As depicted in FIG. 1, there is an illustrated high level block diagram 100 of an embodiment of the present disclosure. The trading app 120 is hosted on the server 130 and can be configured to be adapted to be incorporated into third-party apps that are programmable by computing languages and platforms such as R studio, Matlab, SAS, and Python along with APIs (Quandl, Bloomberg, SQL, Yahoo Finance, and StockTwits). There are also settings to change the functions of the user interface 129 (i.e. hosted on the mobile device (not shown)) to implement automated trading or manual trading, and also monitoring services for a risk management system/fraud services 147. The order/execution manger 145 is connected to the complex processing engine 142 depicted in the trading app 120, which will monitor all asset transactions and orders from the user interface 129 via the Complex Event Processing Engine 142. Within the trading app, there is an admin monitor 156 that will carefully analyze and thoroughly review the entire trading app 120 system process to ensure the trade execution and order is properly followed in the correct sequence.

In various alternate embodiments, the server 130 will receive inputs of data from the Market Data sources 133 which will be smoothed using a data nonnalizer 136 such as a data dimension reduction (or any other normalization filtering techniques available from a host of open source solutions to reduce variance and bias). In other words removing any excess data that's not relevant to the specific task at hand. The Complex Event Processing Engine 142 will receive the data from the market data sources 133 and by algorithmic solutions to generate a model of a stock portfolio and will implement a personalized strategy for the user. The order manager 145 executes transactions in a low latency manner (i.e. higher transactional execution to get the best real time stock price; so has to not affect the stock price or have a least affect on the stock price) by using a lesser number of steps than is normally required using customary online trading accounts such as E-Trade® etc. and perform the transaction. This transaction process is approved for compliance by a check of the FIX Financial Information Exchange 139 and then the order of the transaction is prioritized for routing to a simulator exchange 181. The simulator exchange 181 is a simulated model that enables the user to test different trading strategies to enable learning functions in the application without actually risking strategies that may lose money. After which, the order is sent back to the FIX 139 to ensure the accuracy of the processed transaction and compliance with market regulations. The data of the transaction and completion of the order is then recorded in block 144, after which is then sent to the exchange market 151 (for compliance authority 155).

In various exemplary embodiments, the data may be recorded in a blockchain by the transaction recorder 144 for ensuring the data is not changed and the transaction is a valid transaction. The recorded data is stored in compliance the market rules for the needed period of time. Then once approved, the transaction is sent to the exchange market 151; these steps occur within an execution time of approximately a millisecond or even a nanosecond, in other words, much faster than is humanly possible without high latency.

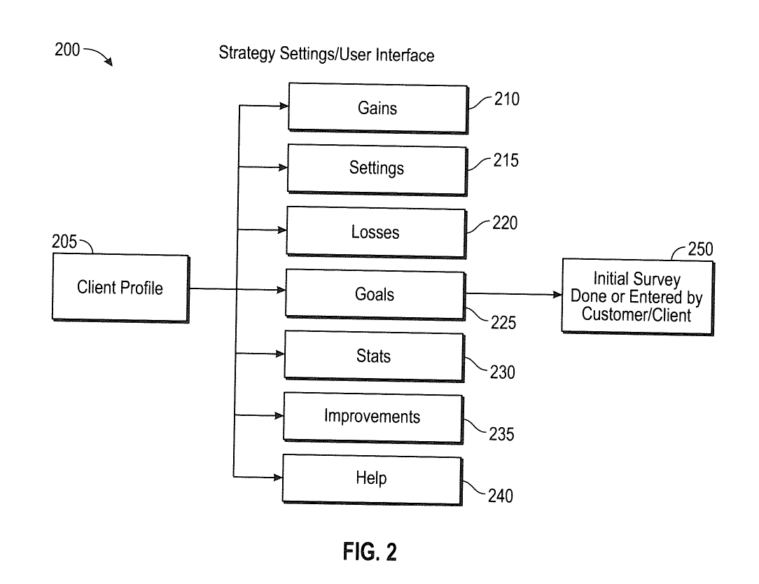

FIG. 2 is an exemplary functional block diagram illustrating the strategy settings and user interface using the MFQA application in accordance with an embodiment. In FIG. 2 there is strategy setting and a user interface 200 system depicting a client profile module 205 that stores data attributes characteristics of the client. This may include the client tolerance for risk, the time that the client needs to place his money for financial gain, and other personalized factors that enable a profile of the particular client to be generated. a gains module 210 to account for gain in assets or stock prices and to predict potential gain in such assets occurring in the portfolio (interest, asset gains, dividends, etc.) at subsequent times, events, quarters etc. as desired by the user. In addition, there is an user setting module 215 to control the client's view of the MFQA trading application. The losses are also depicted in a separate loss module 220 to present the portfolio losses and related costs such as commission, transactional fees etc.). The online questionnaire 250 is a an online questionnaire (similar to those used by SURVEY MONKEY® that resides with the application to that has a set of questions to gain insight into the user goals. The results of the questionnaire are implemented in the client profile 205. In various embodiments, the on-line question answered may be pre-filled or answers may be gained by artificial intelligence and machine learning techniques. For example, associating places using GPS functionality of where the user visits to predict user responses or social internet data about the individual from social network sites. The empirical questions that the user answered can include the user stating the goals of client's account, and if the client wants to change any of their goals. The statistics engine 230 presents an analysis of the user portfolio stats that occurred during the inception of the portfolio date, such as a stock with the most gain/loss, or which asset pays the most interest etc. The improvement module 235 shows improvements which are suggestions given by the algorithm to improve the portfolio and to enable less capital gain taxes to be assessed against the portfolio. The help module 240 provides help to the client by either answering a set of empirical questions, having a file or bulletin word accessible with answers to questions, having a help section that includes comment trails for questions and answers and having an on-demand or chat interface for connecting to an agent or support person when needed.

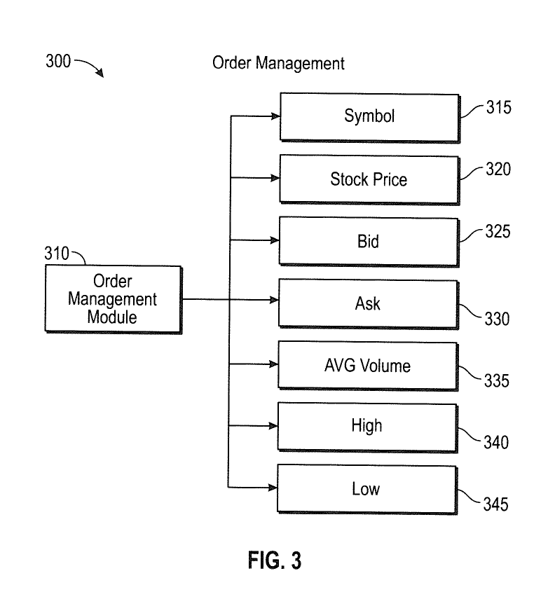

FIG. 3 is an exemplary diagram of the order management system 300 when asset transactions are scheduled for transactions in the marketplace in accordance with an embodiment. The order management module 310 (of FIG. 1) can be configured with multiple inputs to receive data from 3^{rd} party online depositories of financial data including YAHOO!® finance (that may be connected as an example by the yahoo finance API, BLOOMBERG® API, QUANDL® API and STOCKTWITS® API). The symbol 315 is user-friendly input that enables the user by inputting a symbol to somewhere in the neighborhood of 50 different exchanges both domestic and international that are connected to the order management system module 310. The stock prices 320 can be very quickly updated using a data filtration technique by the number of recurrences in system. The bid 325 and the ask 330 block are helpful to users and clients when setting a buy order or a sell order of a stock. However the average volume (not the average volume typically seen from other applications) 335 rather than relying on bid and ask prices for a stock uses the number of recurrences of the stock symbol by measuring the volume of the stock and gives a reasonable advice value on the amount of shares to buy based on the cash value of the client using their specific quantitative strategy. That is, by using a volume weighted average pricing (VWAP) solution to sort the ratio of stock prices (320) to find which price of the stock is at the cheapest at a given time. The VWAP equation is expressed as follows:

$$VWAP = \frac{\sum price \cdot volume at price}{\sum total volume}$$

The order management module 310 uses the equation VWAP which can be explained as the high price plus low price plus the average of all prices multiplied by the volume of prices divided the total share volume. For example, at time Ti the algorithm sums the average of all the prices as well as the high price of the day, low price of the day and closing price of the day of a particular stock which is multiplied by the volume at a particular price divided by the total share volume. This algorithm provides a purchaser of the stock with the best price per day.

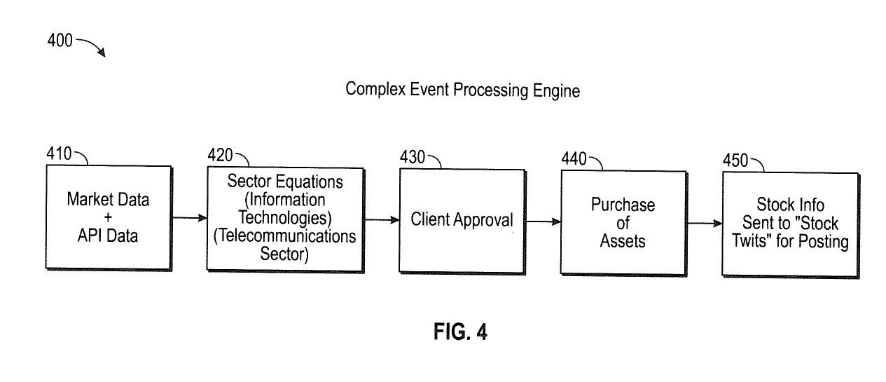

FIG. 4 illustrates an exemplary block diagram demonstrating the Complex Event Processing system using sector equations using various quantitative and qualitative analytics to initialize the trading app system in accordance with an embodiment. In FIG. 4, the market data module 410 receives the current market data. Once the market data 410 is received, the market data is processed by the equations 420 which using a modeling by the multi-factor quantitative analysis (MFQA) equation that sorts through the data.

In an exemplary embodiment, a MFQA equation 420 is modeled for an information technology sector. Briefly, the informational technologies the MFQA equation 420 is modeled about the sum of the constructs as follows: ΣISS+MSS+HRC: for internet software and services (ISS) the algorithm is based on the difference in percentage higher internet software and services compared to the competitors; for multiple sales (MS) is the difference in higher sales of products compared to the competitors product sales (percentage); and for the higher revenue of the competitors (HRC) is the difference in increased revenues compared to revenue of the competitors which should be higher than the previous year. This MFQA equation 420 can be represented by a more detailed model of

$$= \sum ( \frac{p 1 - p 2}{100} - \frac{{ts}_{1 - {ts}_{2}}}{100} - \frac{{ir}_{1 - {ir}_{2}}}{100} )$$

where mₛᵤₘ=Σᵢ₌₁³⁶⁵(rmᵢ+rm₂+ . . . +rm₃₆₅)+(as₁+as₂+ . . . +as₃₆₅)+(pc₁+pc₂+ . . . +pc₃₆₅) is the sum overall manufacturing costs for one year; where nₛᵤₘ=Σᵢ₌₁³⁶⁵(n₁+n₂+ . . . +n₃₆₅) is the sum of the number of products that are made for one year; where mfaₛᵤₘ=Σᵢ₌₁³⁶⁵(m₁+m₂+ . . . +m₃₆₅) is the sum of the manufacturing costs for each product individual for a particular year; where

$$p = {\sum }_{i = 1}^{365} ( \frac{{n}_{sum * {mfa}_{sum}}}{100} )$$

is the sum of the total number of products made in one year and total costs of the each product that is made; where psₛᵤₘ=Σᵢ₌₁³⁶⁵(ps₁+ps₂+ . . . +ps₃₆₅) is the sum of the total sales of product that are sold domestically for a particular company in one year. In addition, the psiₛᵤₘ=Σᵢ₌₁³⁶⁵(psi₁+psi₂+ . . . +psi₃₆₅) is the sum of the total sales for products that are sold international l and are made individually in a one year; where

$$ts = {\sum }_{i = 1}^{365} ( \frac{{psi}_{sum} + {ps}_{sum}}{100} )$$

where t is the total tax liability and psi is the sum of the internationally sold products in one that generates the total income

$$ctr = \frac{Δ t}{Δ psi}$$

where

$${ir}_{sum} = \frac{{\sum }_{i = 1}^{365} ( {TS}_{1} + TS 2 + … {TS}_{365} )}{{\sum }_{i = 1}^{365} ( {cr}_{1} + {cr}_{2} + … {cr}_{365} )} .$$

In another exemplary embodiment, the MFQA equation 420 is modeled for a telecommunication sector. Briefly, the informational technologies the MFQA equation 420 is modeled for this sector about the sum of the constructs as follows: ΣPRS+EF+GOC+AOU. In this case, the sector equations in the telecommunication sector are configured as follows: for regulations added in previous years (PRS) is the difference in percentage regulations added in previous years; the correlation of interest rates affecting stock (EF) is the change in interest rate in percent for a particular stock price compared to a plus or minus percent change for a competitors stock price (+/−); for the difference in growth compared to the growth in previous years (GOC) is he difference in in growth of revenue for a particular company compared to growth generated in previous years in percentage values; and for the amount of users (AOU) is the amount of users that have increased in percent from the amount of users in a previous year or consecutive previous years.

The MFQA equation 420 can be represented by a more detailed model as follows: for the telecommunications sector of:

$${\sum }_{i = 1}^{365} \frac{( {g}_{1} - {g}_{2} )}{100} + \frac{( {irstp}_{1} - {irstp}_{2} )}{100} + \frac{( {goc}_{1} - {goc}_{2} )}{100} + \frac{( aou 1 - aou 2 )}{100}$$

where tgrₛᵤₘ=Σᵢ₌₁³⁶⁵(±tgr₁+tgr₂+ . . . +tgr₃₆₅) is the total governmental regulation cost that affects the net profits of the telecommunication sector; where stpₛᵤₘ=Σᵢ₌₁³⁶⁵(stp₁+stp₂+ . . . +stp₃₆₅) is the stock price in percent changed daily for the individual company; where

$$g = \frac{Δ tgr}{Δ stp}$$

which is the change in regulations of the telecommunications company which depends upon the stock price change; where irₛᵤₘ=Σᵢ₌₁³⁶⁵(ir₁+ir₂+ . . . +ir₃₆₅) is the daily interest rate in percent fluctuation per day; where

$${irstp}_{sum} = \frac{Δ ir}{Δ stp}$$

is the change in the interest rate divided by the change in the stock price where the change is calculated in both instances in a percent change. Next, the rsaₛᵤₘ=Σᵢ₌₁³⁶⁵(rsa₁+rsa₂+ . . . +rsa₃₆₅) is calculated which is the revenue of sales that are generated domestically for each individual company. The taxable income can also be calculated using the corporate tax rate as calculated using the tax rate formula of taxable income of

$$goc = \frac{Δ rsa}{Δ t}$$

which is the growth rate for a company for a particular year.

The aouₛᵤₘ=Σᵢ₌₁³⁶⁵(aou₁+aou₂+ . . . +aou₃₆₅) is the amount of customers for a particular individual company of the international customer based as apposed to the domestic customer base. In other words, directed to only the number of international customers for products and services. As explained previously, in this instance, the market data 410 will be sorted through the MFQA engine via equation 420. The client approval module 430 will send a text/alert or email depending on the notification the user wants to approve the asset transaction. Once approved, the asset will be purchased 440 and the user has a choice if they want the trading app to post the transaction on STOCKTWITS® with the clients name as anonymous for protection of the client 450. By demarcation of products and services and sector categories, in this case two sector categories, more tailored results can be formulated using criteria specific to the sector. In addition, when processing the formulas and equations in each sector, the algorithmic solution can use a particular code that can designate the particular sector in operation to implement the particular sector algorithmic solutions. For example, in the case of two solutions, there would be two codes. It is contemplated for there to be eleven different sector solutions that would require eleven codes that correspond to the eleven sector strategies. In addition, the trading app can be configured to enable a user to select criteria formulated for a specific sector. That is the user can select market factors such as differences in costs for regulations, interest rates; sales differences between competitors and previous year etc. For example, a pull-down menu maybe integrated into the trading app that allows the user to customize and make selections of multi-factors as desired to model an algorithmic solution and further test that solution using a simulated market.

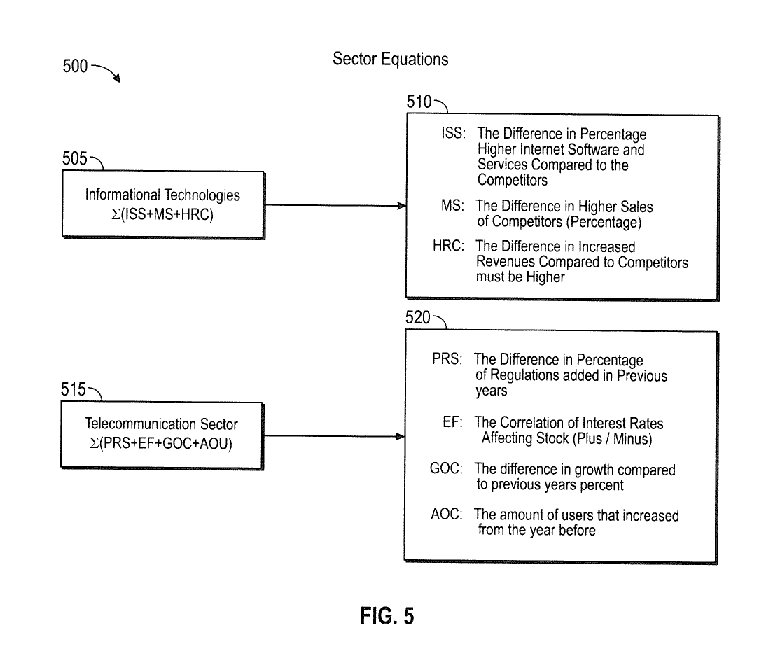

FIG. 5 is a diagram of sector equations for use by the trading app, in accordance with an embodiment. In FIG. 5, the MFQA equations sequences through the market data by applying sector equations (i.e. the sector equations) as explained in FIG. 4 as follows: the Informational Technologies (505) solution of: ΣISS+MSS+HRC; and the Telecommunications Sector (515) solution of: ΣPRS+EF+GOC+AOU.

In an exemplary embodiment, for the market sector of information technologies 505, the sector equations can be configured in 510 as follows: for internet software and services (ISS) the algorithm is based on the difference in percentage higher internet software and services compared to the competitors; for multiple sales (MS) is the difference in higher sales of products compared to the competitors product sales (percentage); and for the higher revenue of the competitors (HRC) is the difference in increased revenues compared to revenue of the competitors which should be higher than the previous year. The numerical value is then measured within an interval of −1.0 to +1.0 (i.e. normalized to a range of plus or minus 1) and if the numerical value for a particular stock is negative, this is indicative of a sell rating, if the numerical value of the particular stock is between the positive and negative intervals, this is indicative of a hold rating and if the numerical rating of the stock is in a positive range this is indicative of buy rating.

In another exemplary embodiment, directed to sector equations used in the telecommunication sector 515; In this case, the sector equations 520 in the telecommunication sector 515 are configured as follows: for regulations added in previous years (PRS) is the difference in percentage regulations added in previous years; the correlation of interest rate s affecting stock (EF) is the change in interest rate in percent for a particular stock price compared to a plus or minus percent change for a competitors stock price (+/−); for the difference in growth compared to the growth in previous years (GOC) is he difference in in growth of revenue for a particular company compared to growth generated in previous years in percentage values; and for the amount of users (AOU) is the amount of users that have increased in percent from the amount of users in a previous year or consecutive previous years. The numerical value that is formulated from the summing operation is normalize to be measured within an interval of −1.0 to +1.0. Similarly, as in the other sector, if the numerical value for a particular stock is negative, this is indicative of a sell rating, if the numerical value of the particular stock is between the positive and negative intervals, this is indicative of a hold rating and if the numerical rating of the stock is in a positive range this is indicative of buy rating.

While two sectors have been described, it is contemplated that the disclosure is not limited to the only two sectors but can include a variety of sectors (i.e. for example 11 sectors of financials, consumer discretionary, consumer staples, information technology, telecommunications, healthcare, real estate, materials, energy etc) with similar sector equations that are tailored to a particular sector. In other words, using the constructs of ISS, MS, HRC and PRS, EF, GOC, AOC; in various combinations, different applicable sector equations can be formulated as desired.

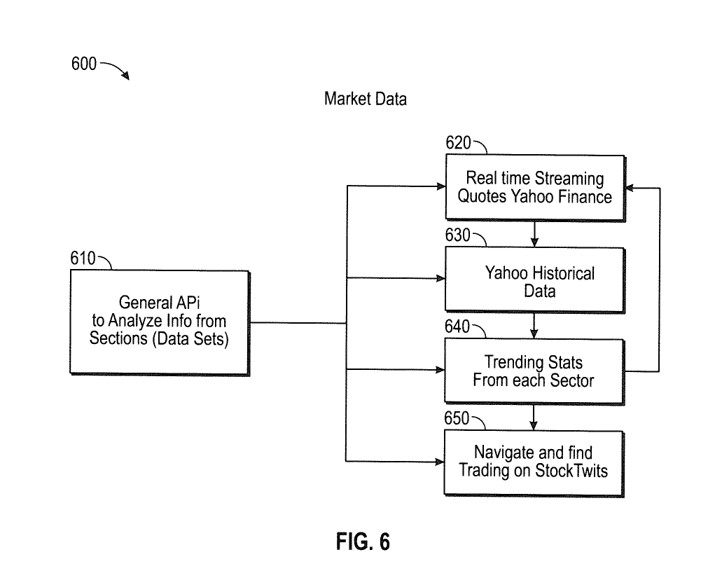

FIG. 6 is an exemplary diagram that illustrates the market data sources that can be used for implementing the Multi-Factor Qualitative Application (MFQA) for the trading app in accordance with embodiment. In FIG. 6, the market data sources 600 includes the general API to analyze information from sectors 610 which instances can be data that is derived from data sheets for each of the sectors. which is essentially an equation demonstrated by blocks. The MFQA Equation is a multi-factor model that is better directed to the relevant factors that are present in the real word today by be constructed based on the 11 sectors that dominate assets in the stock market today that include financials, consumer discretionary, consumer staples, information technology, telecommunications, healthcare, real estate, materials, energy etc. The 11 sectors all have different factors that affect the risk of the sector such as energy is more of a supply and demand sector while information technology's risks are based on political regulations or geopolitical factors. In addition, the MFQA combines the ideals from qualitative finance and quantitative finance creating the use of data used in SWOT analysis to be quantified. The APIs that can be used for market sources can be the real-time streaming of quotes from YAHOO!® finance 620, the YAHOO!® historical data 630, the trending stats that can be derived from each sector 640, and the navigate and find trading that can be executed on STOCKTWITS® 650.

In various exemplary embodiments, data from QUANDL® about different statistics that pertain to each sector can enable the trading app to generate a set of probabilities which then can be routed back to a trending news that is received from trending stats from each sector 640. In the QUANDL®API which can be implemented with the market data sources 600, an analysis and review of the stats can be performed by a presorting through a covariant matrix which can be matched by different identities such as users, unemployment, revenue etc.

In various exemplary embodiments, data from market sources 600 for example can be taglines such as unemployment that pertain to a particular asset sector and can be matched using solutions configured in the trading app to trending news based on the Yahoo Finance API 620 and then matched to a particular stock. The particular stock in turn can be traced back to comments on STOCKTWITS 650 to determine if the particular company is trending and a trend stats can be determined from the applications in the trading app of the trending stats from a particular sector 640 to actually determine if the particular company is actually trending based on actual new tag line data. With real time data from Yahoo Finance will always keep the program in real-time therefore leading to the trading app's data to be based on real time data. Additional implementations may include a TWITTER® feed of data to be used as a market source and for trending analysis. This market trend analysis and verification can be completed within nanoseconds on a exabyte scale, in other words, there is no impact on latency for processing times.

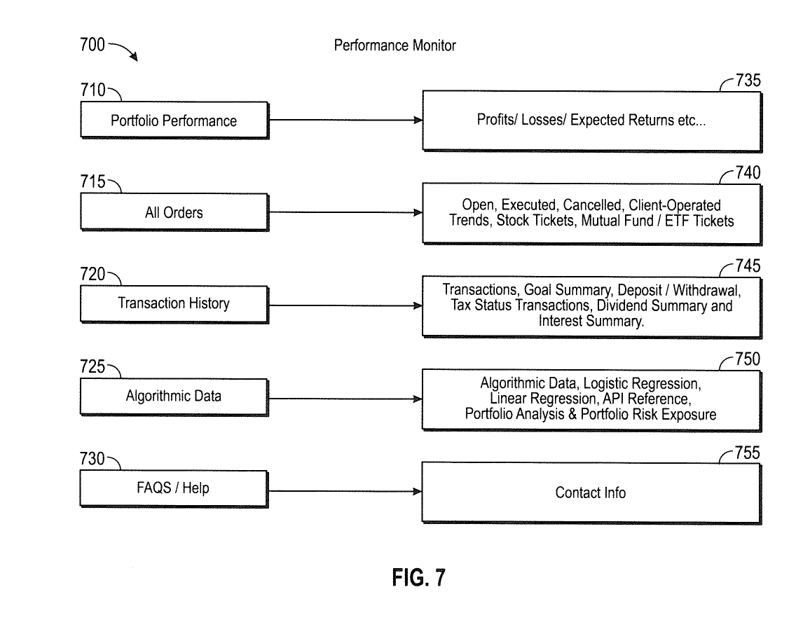

FIG. 7 illustrates an exemplary diagram of performance monitoring 700 in the trading app in accordance with an embodiment. In FIG. 7, the performance monitor includes aspects of performance of an asset portfolio based on a set of statistical computations and comparisons of the asset data that may include a set of modules of a portfolio performance module 710, the cumulative number of orders per sector module 715, the transactional history module 720, the algorithmic data module 725, and the FAQs and HELP requests module 730. For example, the portfolio performance module 710 can include in block 735 data of total net profit, gross profit/loss, commissions, percent profit/loss, max draw down, various indicators, portfolio start date, trade gains and losses, expected returns and comparisons to benchmarks etc. The all orders per sector 715 module can include in block 740, all open orders, all executed orders, all canceled orders, client operated trades, stock ticker displayed for orders, bond tickers displayed, and mutual fund and ETF tickers displayed. The transaction order history module 720 can include in block 745, the transaction number, the goal summary, the amounts and number of deposits and withdrawals, tax status for a particular transaction, dividend summary and interest payment. The algorithm data module 725 can include in block 750, the algorithmic data, session data, logistic regression data, linear regression data, API reference data, portfolio analysis data and portfolio risk exposure data. Finally, the FAQS/Help 730 module can include in block 755, help requests, chat messages, message trails on bulletin boards etc.

In various exemplary embodiments, the performance monitor 700 is an application that record a host of data for assessing a portfolio performance implemented by a portfolio performance module 710 such as the total net profit, gross profit/loss, commission, percent profit/loss, max. drawdown, indicators (MACD, RSI, BBands, etc.), portfolio start date, trade gains/losses, standard deviation, Sharpe Ratio, Expected returns and index benchmarks or other attainable goals. The all orders modules 715 depicts the types of orders such as open, executed, cancelled, client-operated trades and even has a search system courtesy to the Yahoo Finance API to search for Bond Tickers, Mutual Funds/ETF tickers along with Index Funds. The transaction history module 720 depicts transactions, goal summary and tips for the user to attain their goal, deposit/withdrawal function, tax status transactions, dividend summary and interest summary all displayed in a user-friendly manner. The algorithmic Data module 725 can show with full transparency algorithmic data, logistic regressions provided by the algorithm to show clients trends and display log returns, linear regressions to forecast risk and future returns, API reference to show users where the data is coming from, and a fully portfolio analysis which will include a portfolio risk exposure test which is similar to a stress test. The portfolio risk exposure uses a diversification filtering system and creates scenarios and simulates geopolitical events that can harm the portfolio. In exemplary implementations, the trading app can demonstrate by using pre-commanded scenarios from the current news and then under extreme volatility show where risk exists in the portfolio. The performance monitor can be implemented in a command center graphic user interface for real-time monitoring by a compliance or regulatory personnel of a trading portfolio. In addition, a reporting function (not shown) may also be implemented to show reports for sending to users indicating assets, transactions etc. that require further attention to improve portfolio performance. This could be implemented as a premium help feature for a cost, that is an individual could request help in an order and analysis on demand for a particular cost from an analyst or agent at a third party command center. The FAQs/Help module 730 can also be configured to provide contact information and can connect to the help page.

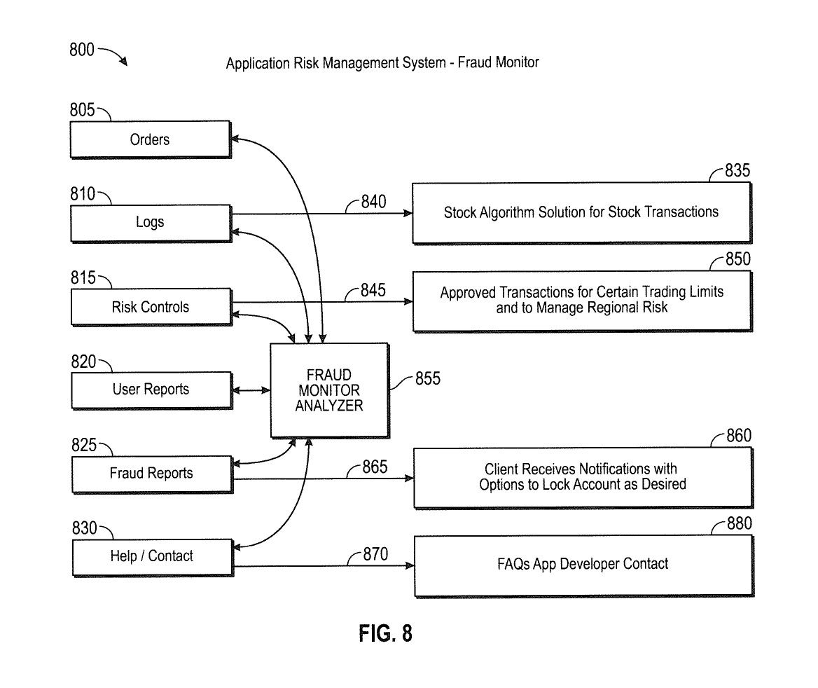

FIG. 8 is an exemplary diagram that illustrates an Application Risk Management System and Fraud Monitor system configured in the trading app in accordance with an embodiment. The Application Risk Management System (ARSM) with fraud monitoring system 800 includes: an orders module 805 which accounts for all the orders that were taken place in the account; for example, whether the orders are executed or cancelled orders, in process to be executed etc. The Logs module 810 generates logs of orders for compliance; for example, when and how an order was ordered for review at a later date and for validating for errors in execution etc. from data generated by a stock algorithmic and transaction module 835. The Logs module 810 can be implemented to display to overcome any lack of transparency by various algorithmic solutions of determining when a transaction is approved or denied and display via a display device of the mobile device (not shown) the transaction change of status in real-time.

In various exemplary embodiments, the algorithmic solutions may provide data for testing of trading strategies and trading programs to be modified or tested via a simulator exchange for integration in a simulated modeling of alternate trading strategies and for testing for alternative trading strategies before the actual implementation of the actual trade.

The risk control module 815 includes a set of rick controls or thresholds that prevents taking of risks that are unduly high based on historic or preset limits. The risk control module 815 sends trading data 845 for approval to preset user modifiable risk limits module 850 for approving managing or denying a trade execution. The user can place trading restrictions such as control the amounts of trades placed by the algorithm or decide whether the user wants to have margin trading or not, etc. The user report center 820 sends statements and portfolio summaries along with IP addresses of users to implement full transparency for all transactions for compliance and risk reduction in trading management. For example, via the client lock out module 860 receiving trading date via 865, the client may be given the option to receive an alert about a trade or to prevent a trade from occurring. The trading reports can be sent either daily, weekly, monthly or yearly. The fraud report module 825 can be configured to send account alerts if IP address changes when an attempt is made to login from an authorized user to the trading app. If the IP address is not recognized by the system, an alert will be sent to the client and no trade can be placed as desired, for a period of time of up to 5 min etc. In instances if the client suggests that fraud has occurred, there can be implemented by the risk control module 815 via the fraud analyzer 855, a lock-down of the account along with an email to the client suggesting an extensive investigation into the matter. The help/contact center 830 via 870 can provide on-demand contact to via FAQ app developer contact module 880 to help agents, historical threads of useful information and questions and answers from other users, and FAQs including references to blogs, videos to assist the user. A search and retrieval of relevant data from REDDITT® or QUORA® or other social news network may also be configured to retrieve additional information.

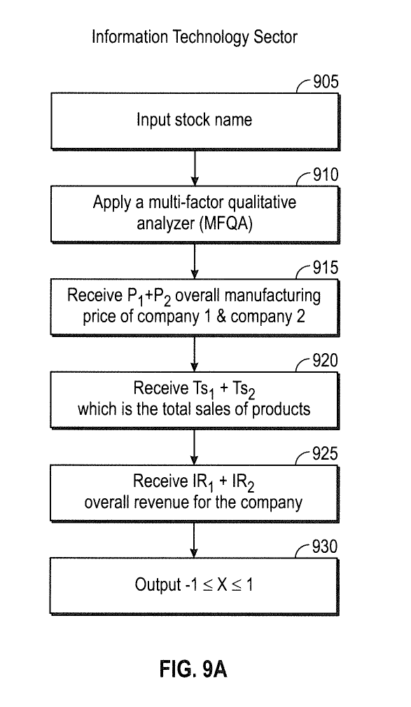

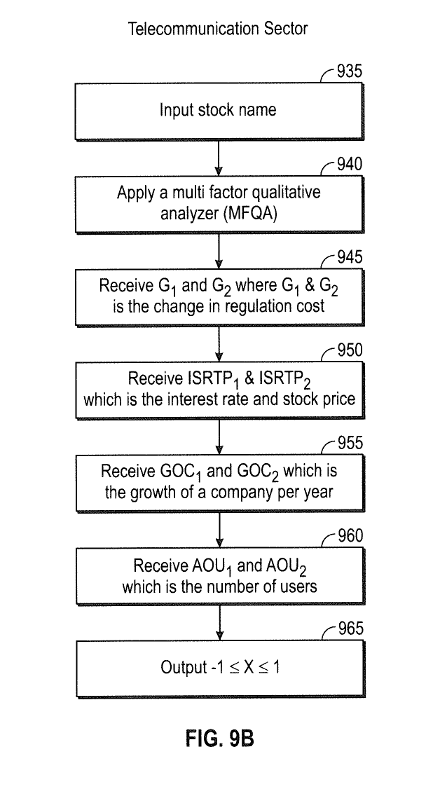

FIGS. 9A and 9B are flowcharts that illustrate the flow process for various sector implementations of in the trading app, in accordance with an embodiment. In FIGS. 9A-9B, the trading app is implemented to compare two companies in the information technology and the telecommunication sector using data received to determine whether or not to buy, hold or sell stock. In FIG. 9A there is shown the flow process for an information technology sector of a configuration of the trading app. In FIG. 9A, a user would input the stock name at 905. Then at 910, the trading app is executed and the multi-factor qualitative analyzer (MFQA) is executed to apply an algorithmic solution configured for the information sector. At 915, data of the price of a company P1 and the price of another company P2 are received for comparison. At 920, data of the total number of sales of a product for each of the companies of TS1 and TS2 is received. At 925, data of the overall revenue for the company IR1 and IR2 is received. At 930, the MFQA using the received data computes an output 930 in the range of plus and minus 1.

In FIG. 9B, an alternative flowchart is shown for a telecommunication sector configuration of the trading app. In FIG. 9B, at 940 the trading app is executed and the multi-factor qualitative analyzer (MFQA) is executed to apply an algorithmic solution configured for the information sector. Then at 945, data is received of the costs for the change in regulations for a company G1 and G2. Next, at 950, data of the interest rate costs and the current stock price as ISRTP1 and ISRTP2 is received. After which, at 955, the growth data of the companies is received of GOC1 and GOC2. Finally, the number of users or customers of the company products is received at 960 for each company of AOU1 and AOU2. At 965, the MFQA using the received data computes an output in the range of plus and minus 1.

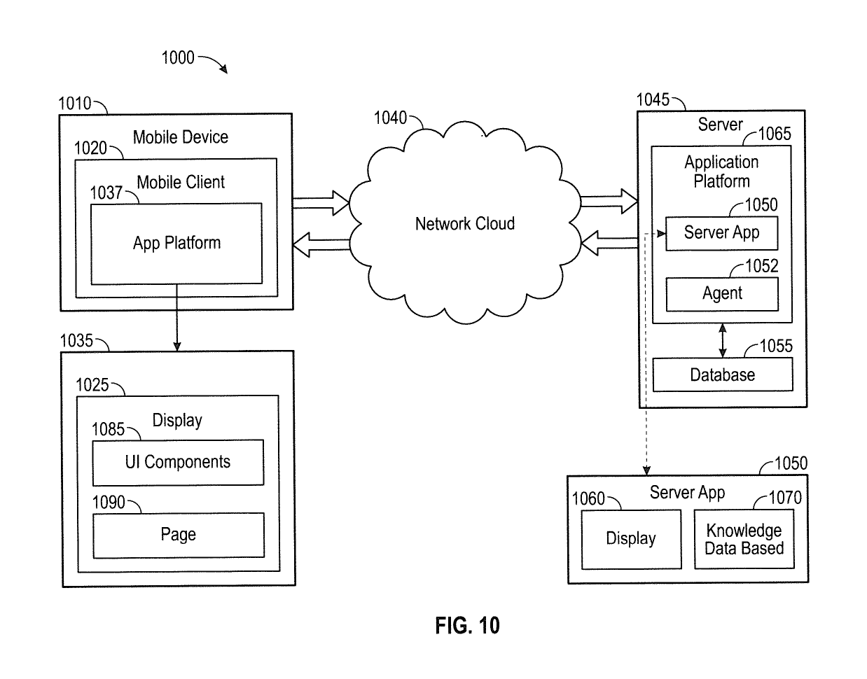

FIG. 10 is a functional block diagram illustrating a trading application architecture with the main components as application, server, and exchange in accordance with an embodiment. With reference to FIG. 10, a cloud based network system 1000 includes the a mobile device 1010 that is configured to host a mobile client 1020 to support the on an app platform 1037 supporting the trading app 1035 that generates a display 1025 configured with components 1085 of a page 1090. The mobile device 1010 communicating via a network cloud 1040 to an application server 1045. The mobile client 1020 may include a browser and for communicating via the network cloud 1040 to the mobile device 1010 and the hosted app platform 1065 by the application server 1045. The network cloud 1040 can include interconnected networks including both wired and wireless networks for enabling communications of the mobile device 1010 via a client 1020 to the application server 1045. For example, wireless networks may use a cellular-based communication infrastructure that includes cellular protocols such as code division multiple access “CDMA”, time division multiple access “TDMA”, global system for mobile communication “GSM”, general packet radio service “GPRS”, wide band code division multiple access “WCDMA” and similar others. Additionally, wired networks include communication channels such as the IEEE 802.11 standard better known as “Wi-Fi”, the IEEE 802.16 standard better known as “WiMAX”, and the IEEE 802.15.1 better known as “Bluetooth”.

The network cloud 1040 allows access to communication protocols and app programming interfaces that enable real-time communication over peer-to-peer connections. In addition, this may include protocols from open source software packages over a cloud based network system 1000. As an example, open source software package for real-time voice and video on the web, can depending on the version be integrated in the Chrome, IOS, Explorer, Safari and other browsers for peer-to-peer communications. Additionally, in-app video-chat communications through different browsers through a uniform standard set of APIs.

The mobile device 1010 includes the mobile client 1020 which in instances may use a mobile software development kit “SDK” platform. This SDK platform can provide one step activation of services via an app application. The mobile device 10 may include any mobile or connected computing device including “wearable mobile devices” having an operating system capable of running mobile apps individually or in conjunction with other mobile or connected devices. Examples of “wearable mobile devices” include Google Glass® and Android® watches. Additionally, connected device may include devices such as cars, jet engines, home appliances, tooth brushes, light sensors, air conditioning systems. Typically, the device will have display capabilities such as a display screens and also may have associated keyboard functionalities or even a touchscreen providing a virtual keyboard and buttons or icons on a display. Many such devices can connect to the internet and interconnect with other devices via Wi-Fi, Bluetooth or other near field communication (NFC) protocols. Also, the use of cameras integrated into the interconnected devices and GPS functions can be enabled.

The mobile client 1020 may additionally include other in-app apps as well as SDK app platform tools and further can be configurable to enable downloading and updating of SDK app platform tools. In addition, the client 1020 uses an SDK platform which may be configurable for a multitude of mobile operating systems including Android®, Apple® iOS, Google® Android®, Research in Motion's BlackBerry® OS, Nokia®'s Symbian, Hewlett-Packard®'s webOS (formerly Palm OS) and Microsoft®'s Windows Phone OS etc.

The application server 1065 can be configured as a platform as a service (“Paas”) that provides a host of features to develop, test, deploy, host and maintain-apps in the same integrated development environment of the app platform. Additionally, the application server may be part of a multi-tenant architecture where multiple concurrent users utilize the same development apps installed on the app platform. Also, by utilizing the multi-tenant architecture in conjunction with the app platform integration with web services and databases via common standards and communication tools can be configured.

The app server platform 1065 includes apps relating to the APIs and objects. The app server platform 1065 may include other apps in communication for accessing a multi-tenant database 1055 as an example, in a multi-tenant database system. In addition, the agent 1052 may configurable to include UIs to display video-chat communication.

The client 1020 includes components 1090 which comprise a page 1090. In a page 1090 there may a variety of different components each generating requests for collecting and monitoring. Components are rendered to produce HTML document object management DOM elements within the browser. component can contain other components, as well as HTML, CSS, JavaScript, or any other Web-enabled code. This enables a developer to build apps with sophisticated UIs. The multiple requests are executed by the event handlers and multiple requests can be processed. As an example, for components 110, a request “doInit”, is called when the component 110 initializes and loads the component 1085 with data. Additionally, a call or request is from a app server controller by an action initiated by a client controller. In a client controller, a callback is set, which is called after the server action is completed. A server action can return any object containing serializable JavaScript Object Notation JSON data.

A client controller is a JavaScript object in object-literal notation containing name-value pairs. Each name corresponds to a client action. Its value is the function code associated with the action data of records associated with the components 110 are returned to the app server platform 1065 to a SQL/SOQL objects when changed.

Additionally, the app platform 1065 has access to other databases for information retrieval and include a local database 1070 where local performance metric data may be stored. The local database 1070 may be part of the multi-tenant database architecture allowing for communication with multi-tenant database or other mobile clients.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Various embodiments of the present disclosure provide systems and method that enable algorithmic solutions to provide enhanced portfolio analysis and trading of financial products for an individual user.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A multi-factor qualitative method for assessing assets comprising:
receiving market data from a plurality of market data sources for processing by a trading app to make decisions as to whether to buy, sell, or hold a particular market asset;
applying a data normalizer to the market data for processing dissimilar sets of market data;
receiving, by user input, a particular market asset in which a decision to buy, sell or hold is required;
processing, the market data by a complex event processing engine using an algorithmic solutions from a particular sector for market analysis of market data to generate a multi-factor model wherein the multi-factor model comprises: at least one of a set of a plurality of multi-factors related to the particular sector;
applying, the multi-factor model by the trading app, to perform a multi-factor analysis of the particular market asset and to generate a set of results; and
making a decision about the particular market asset by the trading app, from the set of results whether to buy, sell or hold the market asset based on a normalized score in the range of plus one to minus one of the set of results wherein a plus one score indicates a decision to buy and a negative one score indicates a decision to sell.

2. The method of claim 1, further comprising:
creating, by the trading app, a user profile for each user wherein the user profile is an additional factor used in the multi-factor model for making a decision whether to buy, sell or hold the particular market asset.

3. The method of claim 1, further comprising:
executing, by an order manager of the trading app, the buy or sell decisions in increments in order maximize profits by preventing increases or reductions in a price of the particular market asset that results from executions of a buy and a sell of a block of the particular market asset.

4. The method of claim 3, further comprising:
creating, a simulator exchange, to model prior to executing the buy or the sell of the block of the particular asset, a simulated buy or sell to determine if one or more expected results are achieved or not.

5. The method of claim 4, further comprising:
applying one or more financial checks by the trading app to ensure that a particular buy or sell of the particular market asset is in compliance.

6. The method of claim 1, further comprising:
applying the algorithmic solution for an information technologies market sector based on one or more factors comprising:
a difference in percentage of costs of software services compared to competitors;
a difference in sales of products compared to competitors; and
a difference in increased revenue compared to competitors.

7. The method of claim 1, further comprising:
applying the algorithmic solution for a telecommunication market sector based on one or more factors comprising:
a difference in percentage of costs for regulations added in previous years;
a correlation of interest rates affecting market assets;
a difference in growth compared to previous years of growth; and
an amount of a change in a number of users for a particular related product or software services to the market asset.

8. A computer program product tangibly embodied in a computer-readable storage device and comprising instructions configurable to be executed by a processor to perform a method for determining market assets based on a set of multiple qualitative and quantitative factors selected by the user using a software product for trading market assets, the method comprising:
receiving market data from a plurality of market data sources for processing by the software product comprising a trading app to make decisions as to whether to buy, sell, or hold a particular market asset;
applying a data normalizer to the market data for processing dissimilar sets of market data;
receiving, by user input to the trading app, a particular market asset in which a decision to buy, sell or hold is required;
processing, the market data by a complex event processing engine using an algorithmic solutions from a particular sector for market analysis of market data to generate a multi-factor model wherein the multi-factor model comprises: at least one of a set of a plurality of multi-factors related to the particular sector;
applying, the multi-factor model by the trading app, to perform a multi-factor analysis of the particular market asset and to generate a set of results; and
making a decision about the particular market asset by the trading app, from the set of results whether to buy, sell or hold the market asset.

9. The method of claim 8, further comprising:
creating, by the trading app, a user profile for each user wherein the user profile is an additional factor used in the multi-factor model for making a decision whether to buy, sell or hold the particular market asset.

10. The method of claim 8, further comprising:
executing, by an order manager of the trading app, the buy or sell decisions in increments in order maximize profits by preventing increases or reductions in a price of the particular market asset that results from executions of a buy and a sell of a block of the particular market asset.

11. The method of claim 10, further comprising:
creating, a simulator exchange, to model prior to executing the buy or the sell of the block of the particular asset, a simulated buy or sell to determine if one or more expected results are achieved or not.

12. The method of claim 11, further comprising:
applying one or more financial checks by the trading app to ensure that a particular buy or sell of the particular market asset is in compliance.

13. The method of claim 8, further comprising:
applying the algorithmic solution for an information technologies market sector based on one or more factors comprising:
a difference in percentage of costs of software services compared to competitors;
a difference in sales of products compared to competitors; and
a difference in increased revenue compared to competitors.

14. The method of claim 8, further comprising:
applying the algorithmic solution for a telecommunication market sector based on one or more factors comprising:
a difference in percentage of costs for regulations added in previous years;
a correlation of interest rates affecting market assets;
a difference in growth compared to previous years of growth; and
an amount of a change in a number of users for a particular related product or software services to the market asset.

15. The method of claim 8 wherein the software product comprises a software-as-a-service (SaaS) application.

16. The method of claim 8 wherein the software product comprises a cloud application.

17. A system comprising:
at least one processor; and
at least one computer-readable storage device comprising instructions configurable to be executed by the at least one processor to perform a method for making decisions about market assets using a multi-factor qualitative model of a cloud trading application, the system comprising:
market data received from a plurality of market data sources for processing by the software product comprising a trading app to make decisions as to whether to buy, sell, or hold a particular market asset;
a data normalizer applied to the market data for processing dissimilar sets of market data;
user input received by the trading app, a particular market asset in which a decision to buy, sell or hold is required;
the market data processed by a complex event processing engine using an algorithmic solutions from a particular sector for market analysis of market data to generate a multi-factor model wherein the multi-factor model comprises: at least one of a set of a plurality of multi-factors related to the particular sector;
the multi-factor model applied by the trading app, to perform a multi-factor analysis of the particular market asset and to generate a set of results; and
the processor configured to make a decision about the particular market asset by the trading app, from the set of results whether to buy, sell or hold the market asset based on a normalized score.

18. The system of claim 17, further comprising:
a multi-factor model generated for an information technologies market sector based on one or more factors comprising:
data of a difference in percentage of costs of software services compared to competitors;
data of a difference in sales of products compared to competitors; and
data of a difference in increased revenue compared to competitors.

19. The system of claim 17, further comprising:
a multi-factor model generated for a telecommunication market sector based on one or more factors comprising:
data of a difference in percentage of costs for regulations added in previous years;
data of a correlation of interest rates affecting market assets;
data of a difference in growth compared to previous years of growth; and
data of an amount of a change in a number of users for a particular related product or software services to the market asset.

20. The system of claim 17, further comprising:
one or more financial checks executed by the trading app to ensure that a particular buy or sell of the particular market asset is in compliance with securities trading regulations.
